(19) United States
(12) Patent Application Publication
(10) Pub. No.: US 2005/0212686 A1
(43) Pub. Date: Sep. 29, 2005

(54) Combination remote controller and liquid ornament

(76) Inventor: Vicent K. Lee, Taipei (TW)

Correspondence Address: BACON & THOMAS, PLLC, 625 SLATERS LANE, FOURTH FLOOR, ALEXANDRIA, VA, 22314, US

(21) Appl. No.: 11/016,846

(22) Filed: Dec. 21, 2004

(30) Foreign Application Priority Data
Mar. 23, 2004 (TW) 093204384

(51) Int. Cl. G08C 19/00

(52) U.S. Cl. 340/825.72

(57) ABSTRACT

A combination remote controller and liquid ornament comprises a remote controller main body and a liquid ornament. The remote controller main body comprises a main housing and a plurality of buttons. The main housing is coupled with a liquid ornament which has at least one liquid and at least one decorative structure being insoluble in the liquid.

### BACKGROUND OF THE INVENTION

1. Field of the Invention

The present invention relates to a combination remote controller and liquid ornament. The remote controller is especially for home electronic equipment such as a TV, a DVD player, a video recorder/player, an audio player, an air conditioner, and a universal remote controller (can control multiple home electronic equipment).

2. Description of the Related Art

A remote controller, especially for home electronic equipment, is a very popular and important device at home. Many people even spend more time on holding a remote controller than holding a computer mouse. Nevertheless, the traditional design of most of remote controllers only focus on changing the shape of remote controllers.

Several patents have been granted regarding the combination of a liquid ornament with other objects to create a decorative effect; for example, in U.S. Pat. No. 6,380,926 several embodiments are disclosed, such as a cup having with a liquid ornament, or a toothbrush box with a liquid ornament.

However, no prior art discloses a combination remote controller and liquid ornament. Remote controllers have been in use for over 30 years, and have become a necessary device for many peoples. Many design shapes for remote controllers are developed each year, but none of the designs contain liquid ornaments.

### SUMMARY OF THE INVENTION

A main objective of the present invention is to provide a combination remote controller and liquid ornament, which causes the remote controller seen more enjoyable and interesting.

Another objective of the present invention is the remote controller main body is a foldable body and the liquid ornament is placed on the pivoting location so that the liquid ornament becomes much more glaring and unique.

In order to achieve the above mentioned objectives, the present invention, a combination remote controller and liquid ornament, comprises a remote controller main body and a liquid ornament. The remote controller main body comprises a main housing and a plurality of buttons. The main housing is coupled with a liquid ornament which has at least one liquid and at least one decorative structure being insoluble in the liquid.

Other objects, advantages, and novel features of the invention will become more apparent from the following detailed description when taken in conjunction with the accompanying drawings.

### BRIEF DESCRIPTION OF THE DRAWINGS

FIG. 1 is a front view of a first embodiment according to the present invention.

FIG. 2 is a side view of a first embodiment according to the present invention.

FIG. 3 is a front view of a second embodiment according to the present invention.

FIG. 4 is a perspective view of a third embodiment according to the present invention, showing the sub-housing and the main housing is under an open status.

FIG. 5 is a perspective view of a third embodiment according to the present invention, showing the sub-housing and the main housing is under a folding status.

FIG. 6 is a perspective view of a forth embodiment according to the present invention.

### DETAILED DESCRIPTION OF THE PREFERRED EMBODIMENT

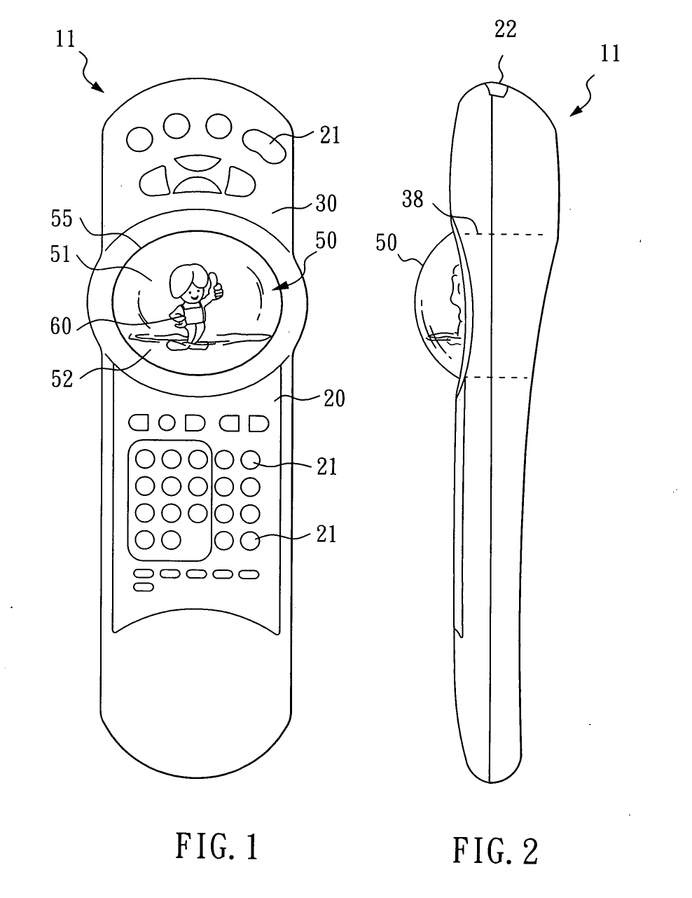

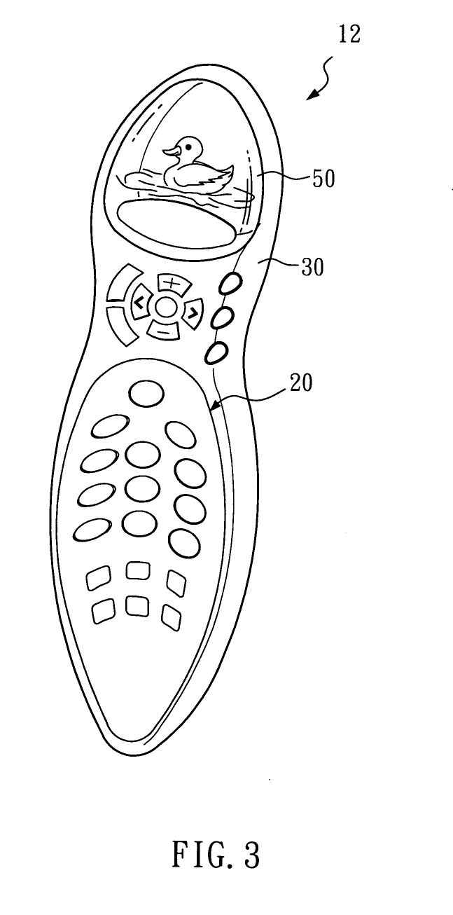

Please refer to FIG. 1 and FIG. 2 for a first embodiment. A combination remote controller and liquid ornament 11 comprises two major components, a remote controller main body 20 and a liquid ornament 50.

The remote controller main body 20 comprises a main housing 30, a plurality of buttons 21 and an infrared rays module 22. The electronic circuit connected with infrared rays module 22 is inside the main housing 30 but not shown in the drawings. A user presses the buttons 21 to control a remote device (e.g. TV). The details of the remote controller main body 20 is not within the field of the subject matter of the present invention, and so details of such a mechanism for the electronic circuit or theory of the infrared rays module 22 are not explained hereafter.

The subject matter of the present invention is the main housing 30 of the remote controller main body 20 is further coupled with the liquid ornament 50. The liquid ornament 50 comprises at least one liquid and a decorative structure 60. According to the embodiment, there are two liquids, a first liquid 51 and a second liquid 52. The second liquid 52 is less dense than the first liquid 51, and they usually have different colors. The decorative structure 60 is insoluble and floats between the first liquid 51 and the second liquid 52.

In the first embodiment, the liquid ornament 50 is mounted near the top (i.e. same direction of the infrared rays module 22) of the main housing 30. There are many ways to fix the liquid ornament 50 on the main housing 30. However, since combining two objects are well known, the detailed description for doing so is omitted. The main housing 30 preferably has a through hole 38 corresponding to the mounting area of the liquid ornament 50. Therefore, the liquid ornament 50 can be mounted on the through hole 38 to show the beauty of the liquid ornament 50.

Please refer to FIG. 2 for a second embodiment, the combination remote controller and liquid ornament 12. In comparison with the aforesaid first embodiment, the major difference is that the liquid ornament 50 is the liquid ornament 50 is coupled with the top area of the main housing 30.

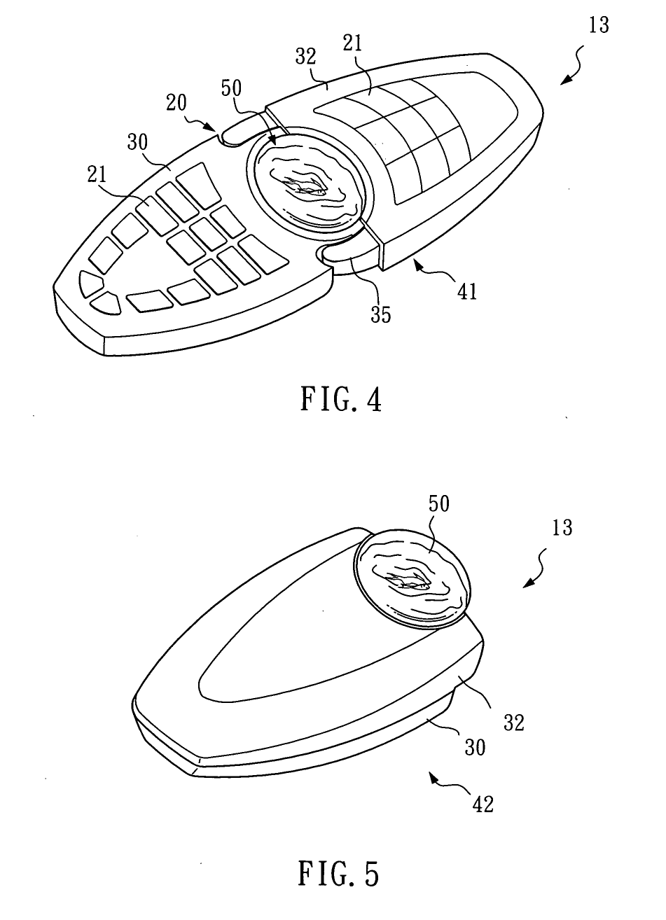

Please refer to FIG. 4 and FIG. 5 for a third embodiment. A combination remote controller and liquid ornament 13 further comprises a sub-housing 32 and a pivot mechanism 35. The main housing 30 is connected with the sub-housing 32 through the pivot mechanism 35 so that the sub-housing 32 can have an open status 41 (FIG. 4) and a folding status 42 (FIG. 5) relatively to the main housing 30. Since the pivot mechanism 35 is well known, the detailed description for doing so is omitted. Furthermore, the liquid ornament 50 preferably locates between the sub-housing 32 and the main housing 30, so when the sub-housing 32 and the main housing 30 are under the folding status 42 (FIG. 5), the liquid ornament 50 becomes much more glaring and unique. In addition, the buttons 21 are disposed on both of the sub-housing 32 and the main housing 30 and no buttons 21 are exposed under the folding status 42.

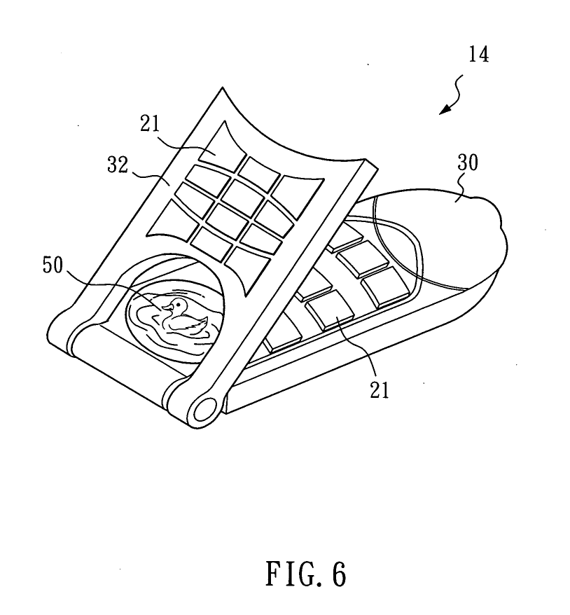

Please refer to FIG. 6 for a forth embodiment, the combination remote controller and liquid ornament 14. In comparison with the aforesaid third embodiment, the major difference is that buttons 21 disposed on the different side of the sub-housing 32 so that buttons 21 on the sub-housing 32 are exposed under the folding status 42.

Please be noted that the aforesaid third and forth embodiments may also have a through hole (not shown) like the first embodiment. Thus, the liquid ornament 50 can be mounted on the through hole too.

Although the present invention has been explained in relation to its preferred embodiment, it is to be understood that many other possible modifications and variations can be made without departing from the spirit and scope of the invention as hereinafter claimed. For example, the through hole is not necessarily required, or the liquid ornament can be mounted on the rear area (opposite to the direction of the infrared rays module) of the main housing.

1. A combination remote controller and liquid ornament comprising a remote controller main body, wherein the remote controller main body comprises a main housing and a plurality of buttons, characterized in that the main housing further being coupled with a liquid ornament, wherein the liquid ornament comprising at least one liquid and at least one decorative structure being insoluble in the liquid.

2. The combination remote controller and liquid ornament as claimed in claim 1, wherein the main housing further comprises a through hole and the liquid ornament is mounted in the through hole.

3. The combination remote controller and liquid ornament as claimed in claim 1, wherein the remote controller main body further comprises a sub-housing pivotly connecting with the main housing so that the sub-housing can have an open status and a folding status relatively to the main housing.

4. The combination remote controller and liquid ornament as claimed in claim 3, wherein the liquid ornament locates between the sub-housing and the main housing.
